(19) United States
(12) Patent Application Publication
(10) Pub. No.: US 2010/0191547 A1
(43) Pub. Date: Jul. 29, 2010

(54) SYSTEM OF OBTAINING AND MANIPULATING INSURANCE COMPANY IDENTITIES THROUGH PHYSICIAN PROVIDED NETWORK DATABASE

(76) Inventor: Scott Brandt, Woodland Hills, CA (US)

Correspondence Address: John Alumit, 16830 Ventura Blvd. Suite 360, Encino, CA, 91436, US

(21) Appl. No.: 12/510,127

(22) Filed: Jul. 27, 2009

Related U.S. Application Data
(60) Provisional application No. 61/083,921, filed on Jul. 26, 2008.

(51) Int. Cl. G06Q 40/00; G06Q 50/00; G06F 17/30

(52) U.S. Cl. 705/4; 707/769; 707/E17.014

(57) ABSTRACT

A method and system for enrolling a user in at least one health insurance plan based on at least one doctor selected by the user. The user enters applicable information to search for at least one doctor. A search for the doctor(s) is performed in a doctor database of at least one insurance carrier accepted by the doctor(s). A search result of the doctor(s) is displayed and the user selects the doctor(s) from the search result. The user then selects at least one insurance carrier accepted by the doctor(s) and enters a plurality of details to generate at least one rate quote for a health insurance plan. The user compares and selects the desired plan on the basis of a plurality of benefits. The user then completes and submits the health insurance plan. Customizing and updating options are available on the website through which the method and system is executed.

### CROSS-REFERENCE TO RELATED APPLICATION

This application claims the benefit of the priority date of provisional application No. 61/083,921, filed on Jul. 26, 2008.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a method and system for enrolling at least one user in a health insurance plan, and more particularly to an improved method and system for enrolling at least one user in a health insurance plan accepted by at least one doctor.

The health insurance industry offers a wide variety of health insurance products and plans to consumers. Costs of the health insurance industry are rapidly increasing due to advancement in treatments using modern medical technology. This has become burdensome for a large percentage of insurance buyers as premiums are too high. Consequently, buyers must switch their plans to save money. There are many health insurance providers that offer guidance to users in choosing appropriate insurance plans. But many insurance buyers wish to retain their doctors when switching to a new insurance plan.

Several methods for offering health insurance plans to insurance buyers have been developed in the art. For example, U.S. Patent Application No. 20060293928 to Schumacher on Dec. 28, 2006 provides a system and method to recommend at least one health insurance plan to a user via a computer network. The method includes presenting at least one question to a user via a client device. The question may be for identification of at least one insurance plan and an answer to the question. A database may be investigated to identify a subsequent question associated with the answer provided to the first question by the user, wherein the subsequent question is also for identification of the at least one insurance plan. Thereafter, the subsequent question is presented to the user and a subsequent answer to the subsequent question is then received.

U.S. Pat. No. 6,343,271 issued to Peterson on Jan. 29, 2002 discloses a claims processing system for electronically reviewing and adjudicating medical insurance claims. The claims processing system includes a benefits system, an automated adjudication system, a payment system, and a payment tracking system. The benefits system allows patients and health care providers to access patient and benefits information on-line. Using the automated adjudication system, health care providers may electronically prepare and submit claims for payment.

U.S. Pat. No. 6,067,522 issued to Warady on May 23, 2000 provides a health and welfare benefit enrollment and billing system and method. The method enrolls a person in a health and welfare benefit plan provided by health and welfare benefit plan providers. The system comprises an enrolling means for enrolling the person in the health and welfare benefit plan and a bill generating means for generating a bill as a result of enrolling the person in the health and welfare benefit plan by the health and welfare benefit plan provider.

Most of the above methods for selecting health insurance plans for a user have considerable drawbacks. In such methods, the user is not able to retain their desired doctors when they switch to a new health insurance plan unless they search for the respective doctor in each website of the health insurance providers. Furthermore, such methods prompt the user to respond to a vast number of questions for the identification of a suitable plan. Moreover, the user must endure the tedious process of searching in several websites of insurance providers for choosing a health insurance plan.

It is therefore an object of the present invention to provide a simple method for a user to retain their desired doctors when they switch to a new insurance plan. Another object of the invention is to provide a hassle free method that avoids the tedious process of searching through many websites of insurance providers when selecting health insurance. Other objects of the present invention will become better understood with reference to appended Summary, Description and Claims.

### SUMMARY

The present invention is a method for enrolling at least one user in at least one health insurance plan accepted by at least one doctor using a website. The at least one user accesses the website through a network and enters applicable information to search the at least one doctor in the website. The website searches for the at least one doctor in a doctor database of the at least one insurance carrier accepted by the at least one doctor. A search result that includes a list of details of the at least one doctor is displayed. The method allows the at least one user to search for another doctor after selecting the at least one doctor from the search result. The at least one user selects the at least one insurance carrier enrolled by the at least one doctor and enters a plurality of details to generate at least one rate quote. Then, the user compares and selects the at least one health insurance plan on the basis of a plurality of benefits. The at least one user completes and submits the at least one health insurance plan selected by the at least one user.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### FIGURES

FIG. 1 is a schematic diagram of the present invention, illustrating a method for enrolling at least one user in at least one health insurance plan accepted by at least one doctor by selecting at least one insurance carrier using a website.

FIG. 2 is an operational flow chart of the present invention, illustrating a method for enrolling at least one user in at least one health insurance plan accepted by at least one doctor.

FIG. 3 is a screenshot of a webpage of the present invention, illustrating a home page for entering applicable information to search at least one doctor.

FIG. 4 is a screenshot of a webpage of the present invention, illustrating a search result that includes a list of details of at least one doctor.

FIG. 5 is a screenshot of a webpage of the present invention, illustrating at least one insurance carrier enrolled with the at least one doctor.

FIG. 6 is a screenshot of a webpage of the present invention, illustrating a plurality of details to generate at least one rate quote.

FIG. 7 is a screenshot of a webpage of the present invention, illustrating a plurality of related information of at least one health insurance plan accepted by at least one doctor.

FIG. 8 is a screenshot of a webpage of the present invention, illustrating a plurality of related information of at least one health insurance plan accepted by at least one doctor and a pop-up window to save the least one health insurance plan including the plurality of related information.

FIG. 9 is a screenshot of a webpage of the present invention, illustrating comparison and selection of at least one health insurance plan on the basis of a plurality of benefits.

FIG. 10 is a screenshot of a webpage of the present invention, illustrating customization of a plurality of benefits for comparing at least one health insurance plan.

FIG. 11 is a screenshot of a webpage of the present invention, illustrating completion and submission of at least one health insurance plan selected by at least one user.

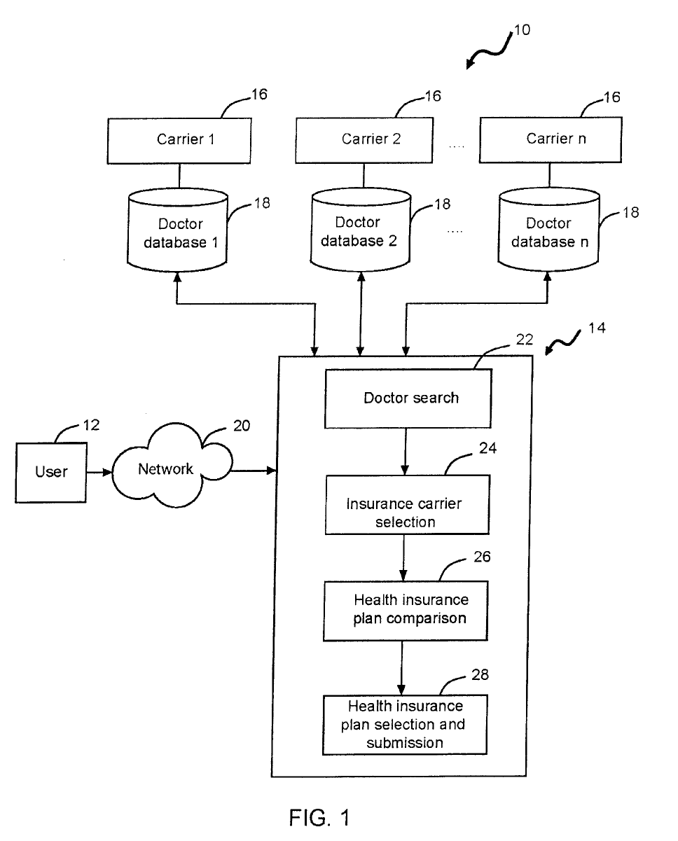

The following reference numeral are represented in FIGS. 1 through 11:
10 . . . A method and system for enrolling at least one user in at least one health insurance plan accepted by at least one doctor
12 . . . At least one user
14 . . . A website
16 . . . At least one health insurance carrier
18 . . . A doctor database
20 . . . A network
22 . . . A doctor search
24 . . . An insurance carrier selection
26 . . . A health insurance plan comparison
28 . . . A health insurance plan selection and submission
30 . . . Entering applicable information to search at least one doctor
32 . . . Searching at least one doctor in a doctor database
34 . . . Checking a match for at least one doctor
36 . . . Refine search
38 . . . Displaying a search result that includes a list of details of the at least one doctor
40 . . . Selecting the at least one doctor from the search result
42 . . . Checking to search another doctor
44 . . . Displaying at least one insurance carrier
46 . . . Selecting at least one insurance carrier
48 . . . Entering a plurality of details of a user for generating at least one rate quote
50 . . . Checking to add a member
52 . . . Entering a plurality of details of a member
54 . . . Displaying at least one health insurance plan that includes a plurality of related information
56 . . . Comparing and selecting at least one health insurance plan
58 . . . Completing and submitting at least one health insurance plan
60 . . . A home page for entering applicable information
62 . . . “Know more details” link
64 . . . Type of application
66 . . . At least one network of health care provider
68 . . . “No preference” option
70 . . . “FIND” button
72 . . . “Don't have a doctor but want to find a plan?” link
74 . . . A search result
76 . . . “Details” link
78 . . . “Select” link
80 . . . “EDIT” button
82 . . . “ADD ANOTHER DOCTOR” button
84 . . . “VIEW ACCEPTED CARRIERS” button
86 . . . A list of at least one insurance carrier
88 . . . A list of at least one doctor
90 . . . At least one “View plan” check box
92 . . . “START QUOTE” button
94 . . . A plurality of details of at least one user
96 . . . At least one payment preference
98 . . . “For best results” link
100 . . . “ADD MEMBER” button
102 . . . “GET QUOTE” button
104 . . . A plurality of related information of at least one health insurance plan
106 . . . “EDIT MY PREFERENCE” button
108 . . . “COMPARE PLANS” button
110 . . . A pop-up window
112 . . . A plurality of benefits
114 . . . “SELECT” button
116 . . . A window for customizing a plurality of benefits
118 . . . “Customize” link
120 . . . “UPDATE” button
122 . . . An option for user notification
124 . . . “APPLY” button

### DESCRIPTION

Referring to the drawings, a preferred embodiment of a method and system for enrolling at least one user 12 in at least one health insurance plan accepted by at least one doctor by selecting at least one insurance carrier 16 using a website 14 is illustrated and generally indicated as 10 in FIGS. 1 through 11. With reference to FIG. 1 the at least one user 12 accesses the website 14 through a network 20 and enters applicable information in the website 14 for performing a search 22 for the at least one doctor. The website 14 searches through a doctor database 18 of the at least one insurance carrier 16. The at least one user 12 performs an insurance carrier selection 24 for selecting the at least one insurance carrier 16 enrolled by the at least one doctor and performs a health insurance plan comparison 26. The at least one user 12 selects the at least one health insurance plan accepted by the at least one doctor and performs a health insurance plan submission 28.

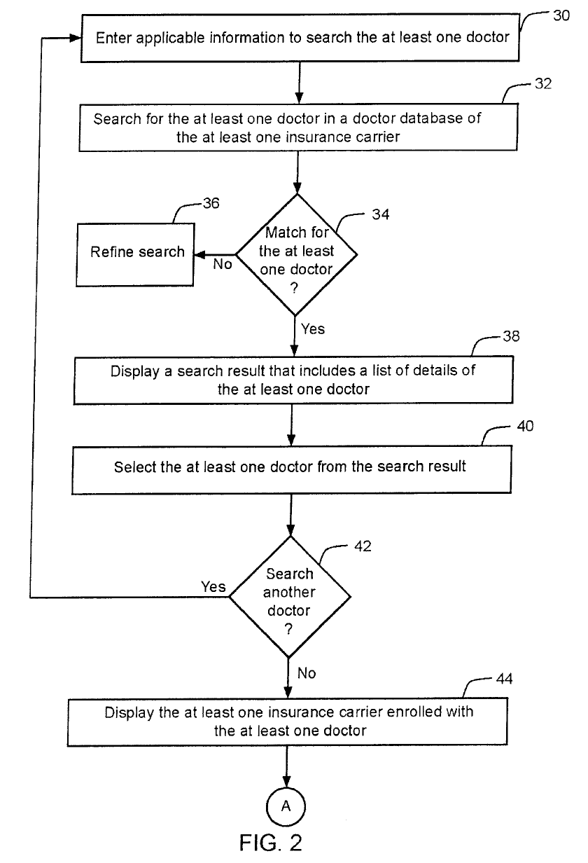

Referring to FIG. 2, an operational flowchart illustrates a method for enrolling at least one user in at least one health insurance plan accepted by at least one doctor. The at least one user enters applicable information to search the at least one doctor in a website as indicated at block 30. The website searches for the at least one doctor in a doctor database of at least one insurance carrier accepted by the at least one doctor as indicated at block 32. A check is made at block 34 to verify a match for the at least one doctor in the doctor database. If the check made at block 34 is evaluated to “Yes”, a search result that includes a list of details of the at least one doctor is displayed as indicated at block 38. If the check made at block 34 is evaluated to “No”, the search result displays a no match message and the at least one user can refine the search for the at least one doctor by clicking “EDIT” button to make changes on the applicable information as indicated at block 36. The at least one user selects the at least one doctor from the search result as indicated at block 40. A check is made at block 42 to determine whether to search another doctor in the doctor database of the at least one insurance carrier. If the check made at block 42 is true, control is transferred to the block 30. If the check made at block 42 is evaluated to false, the at least one insurance carrier enrolled with the at least one doctor is displayed as indicated at block 44 and the at least one user selects the at least one insurance carrier as indicated at block 46. The at least one user enters a plurality of details to generate at least one rate quote as indicated at block 48. A check is made at block 50 to determine whether the at least one user wants to add a member. If the check is true then the at least one user can consecutively enter a plurality of details of the member as indicated at block 52 to generate the at least one rate quote. If the check made at block 50 is false the at least one health insurance plan that includes a plurality of related information is displayed as indicated at block 54. The at least one user compares and selects the at least one health insurance plan on the basis of a plurality of benefits as indicated at block 56. Finally, the at least one user completes and submits the at least one health insurance plan as indicated at block 58.

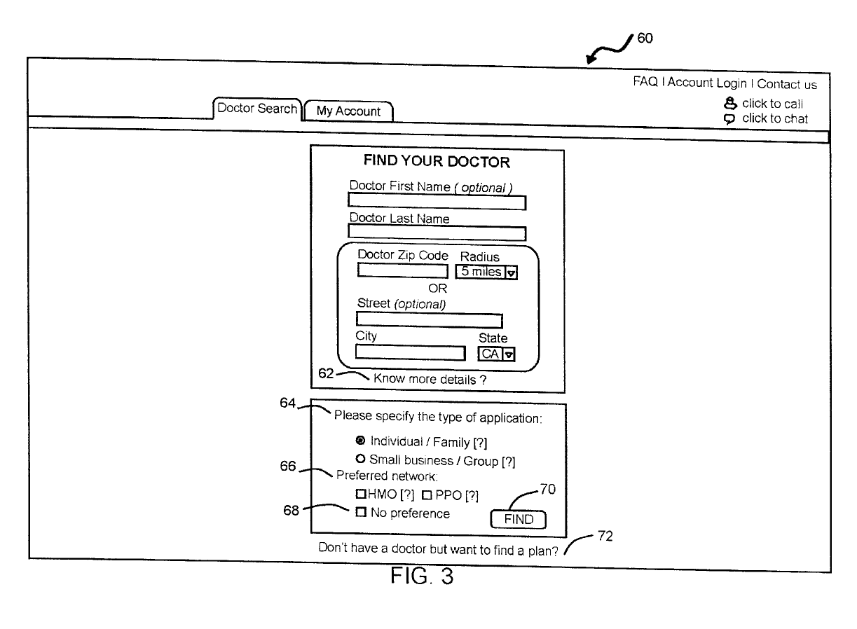

FIG. 3 is a screenshot illustrating a home page for entering applicable information 60 to search at least one doctor or the like. The applicable information may include name, zip code, radius, city, state of the at least one doctor. At least one user 12 can click “know more details?” link 62 to enter more details of the at least one doctor. The at least one user 12 can specify the type of application 64 which may include an individual, a family, a small business, a group or the like. The applicable information facilitates the at least one user 12 to choose at least one network of health care provider 66. The at least one network of health care provider 66 may be health maintenance organization (HMO), preferred provider organization (PPO) or the like. If the at least one user 12 does not want to choose the at least one network of health care provider 66 “No preference” option 68 is selected. The at least one user 12 clicks “FIND” button 70 to search the at least one doctor. If the at least one user 12 does not have at least one doctor, then the at least one user 12 clicks “Don't have a doctor but want to find a plan?” link 72. The link 72 directs the at least one user 12 to search at least one health insurance plan.

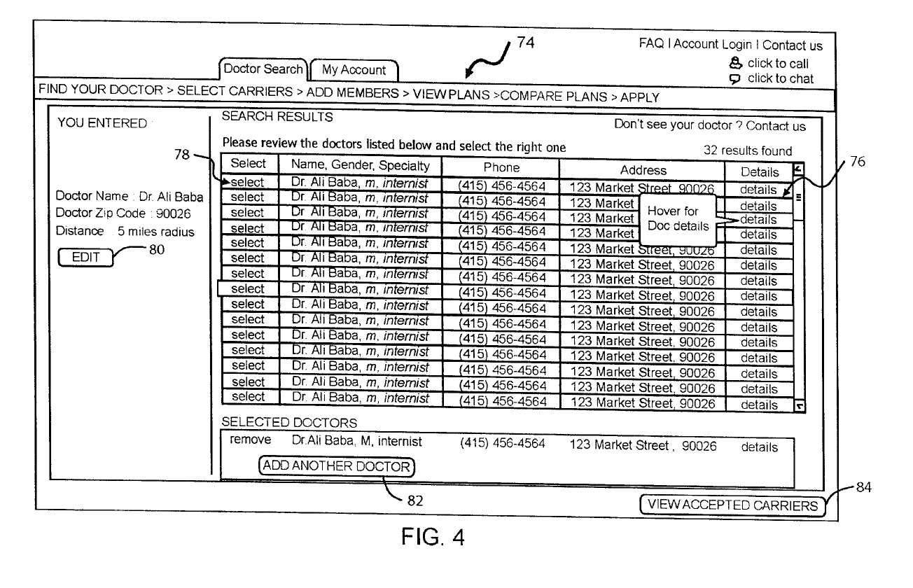

FIG. 4 is a screenshot of a web page illustrating a search result 74 that includes a list of details such as name, gender, specialty, phone, address of at least one doctor. At least one user 12 clicks “details” link 76 to retrieve more details of the at least one doctor such as languages spoken by the at least one doctor, hospitals affiliated with the at least one doctor or the like. The at least one user 12 clicks “select” link 78 to select the at least one doctor from the search result 74. The at least one user 12 clicks “EDIT” button 80 to refine the applicable information entered to search the at least one doctor. The at least one user 12 can search for another doctor subsequently after selecting the at least one doctor from the search result 74. To search another doctor, the at least one user 12 clicks “ADD ANOTHER DOCTOR” button 82. The at least one user 12 clicks “VIEW ACCEPTED CARRIERS” button 84 to view at least one insurance carrier 16 enrolled by the at least one doctor.

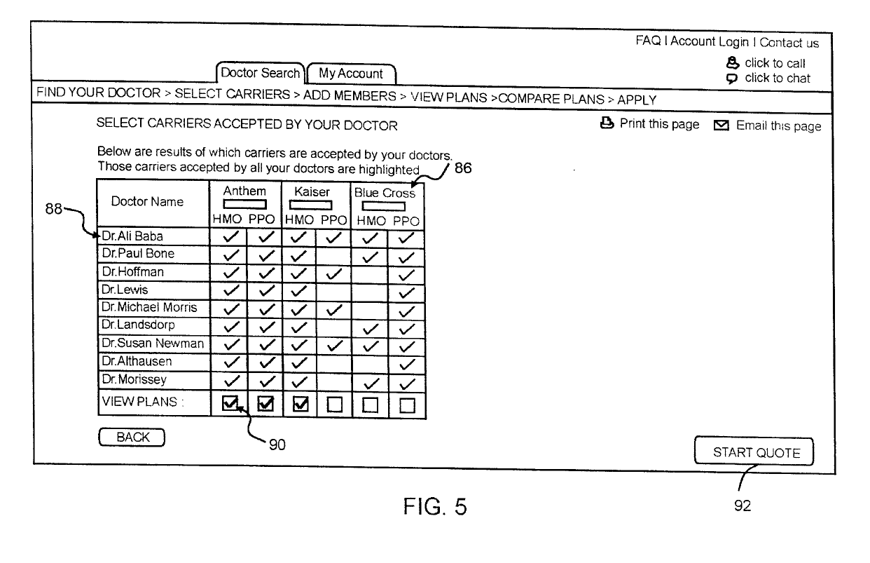

FIG. 5 is a screenshot of a web page illustrating at least one insurance carrier 16 enrolled with at least one doctor. A list of the at least one insurance carrier 86 along with a list of at least one doctor 88 enrolled with the at least one insurance carrier 16 is displayed. At least one user 12 selects the at least one insurance carrier 16 enrolled by the at least one doctor by selecting at least one “VIEW PLANS” check box 90 associated with the at least one insurance carrier 16. The at least one user 12 clicks “START QUOTE” button 92 to generate at least one rate quote on the at least one health insurance plan.

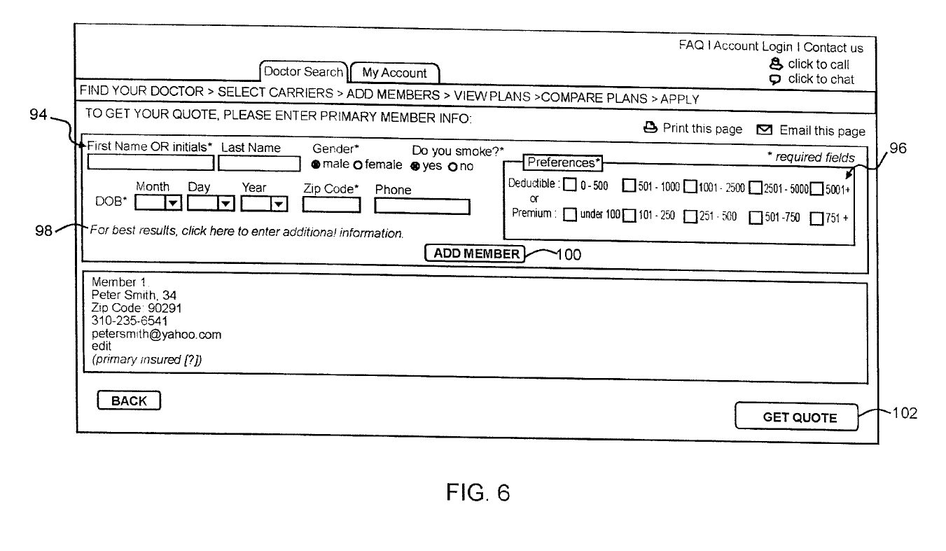

FIG. 6 is a screenshot of a web page illustrating a plurality of details 94 of at least one user 12 to generate at least one rate quote. The plurality of details 94 of the at least one user 12 includes name, gender, date of birth, zip code, phone or the like. At least one user 12 can choose at least one payment preference 96 such as deductible preference, premium preference or the like. The at least one user 12 clicks “For best results” link 98 to enter additional information of the at least one user 12. The additional information includes maternity coverage, prescription drug coverage, current monthly premium or the like. The at least one user 12 can enter a plurality of details to add a member to generate the at least one rate quote by clicking “ADD MEMBER” button 100. The at least one user clicks “GET QUOTE” button 102 to generate the at least one rate quote.

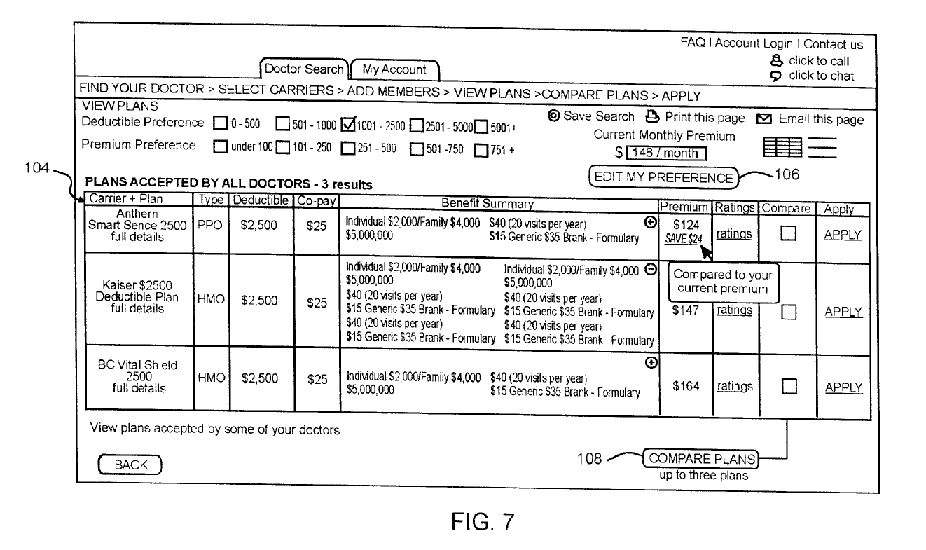

FIG. 7 is a screenshot of a web page illustrating at least one health insurance plan that includes a plurality of related information 104. The plurality of related information 104 includes at least one network of health care provider 66, Co-pay, benefit summary, premium, ratings or the like. At least one user 12 can edit at least one payment preference 96 by clicking “EDIT MY PREFERENCES” button 106. The at least one user 12 clicks “COMPARE PLANS” button 108 to compare the at least one health insurance plan.

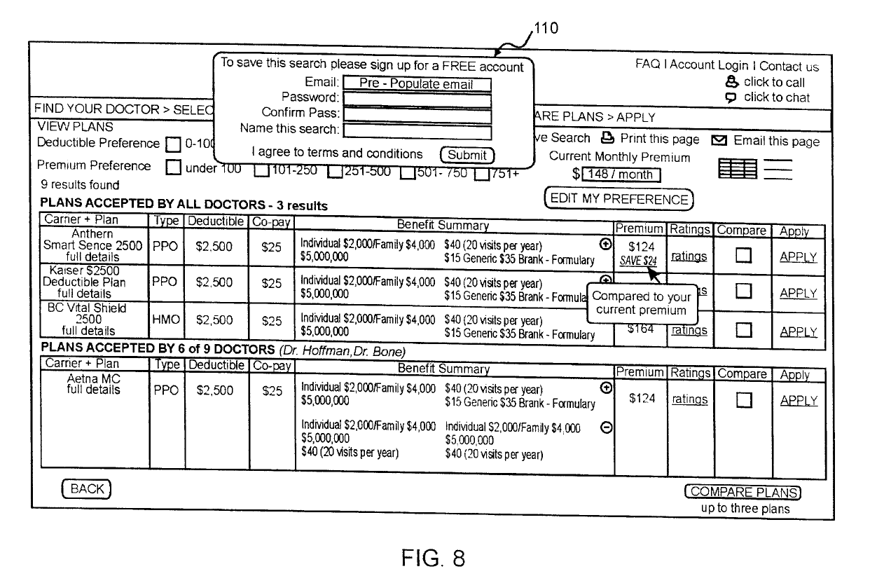

FIG. 8 is a screenshot of a web page illustrating a plurality of related information 104 of at least one health insurance plan accepted by at least one doctor and a pop-up window 110 to save the least one health insurance plan including the plurality of related information 104. At least one user 12 enters requested information to save the at least one health insurance plan including the plurality of related information 104. The requested information may include email id, password or the like.

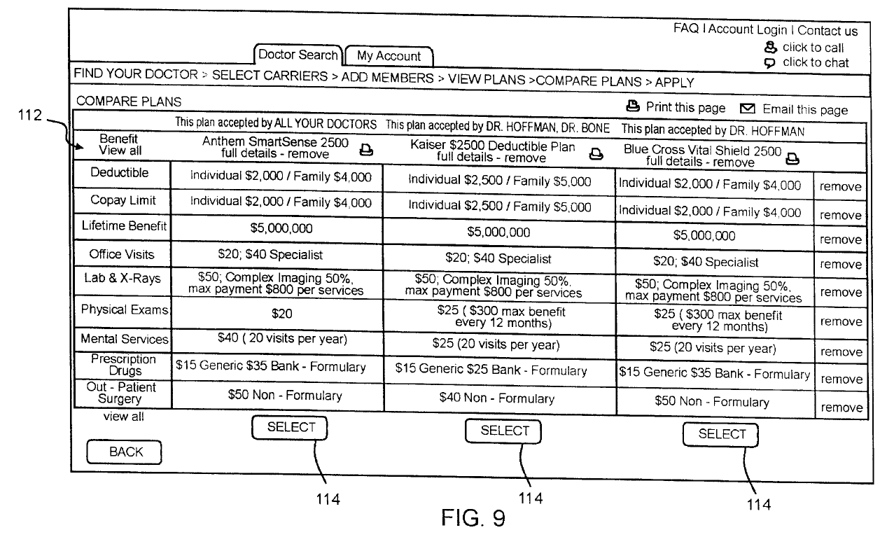

FIG. 9 is a screenshot of a web page illustrating comparison and selection of at least one health insurance plan on the basis of a plurality of benefits 112. At least one user 12 clicks “SELECT” button 114 to select the at least one health insurance plan.

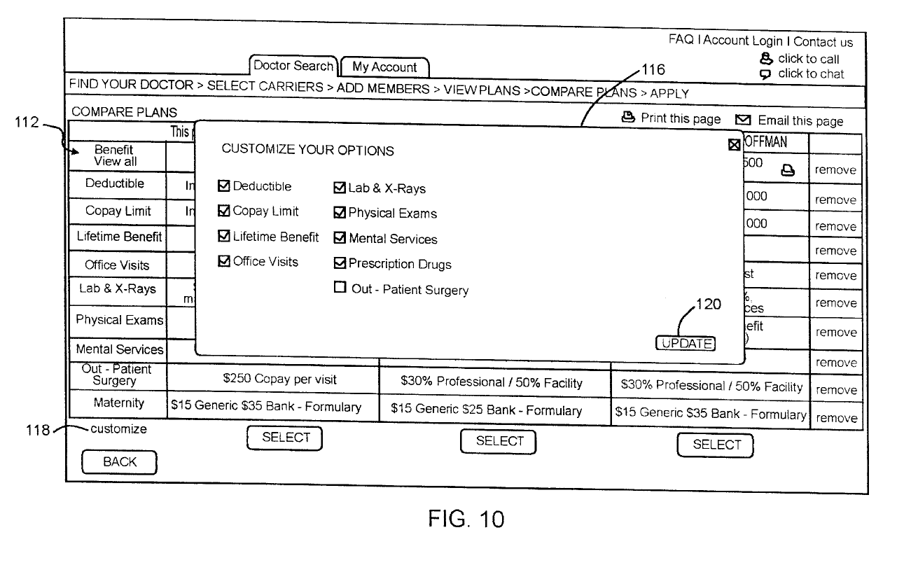

FIG. 10 is a screenshot of a web page illustrating a window 116 for customizing a plurality of benefits 112 for comparing at least one health insurance plan. At least one user 12 clicks “customize” link 118 to display the window 116 for choosing the plurality of benefits 112. After choosing the plurality of benefits 112 the at least one user 12 clicks “UPDATE” button 120.

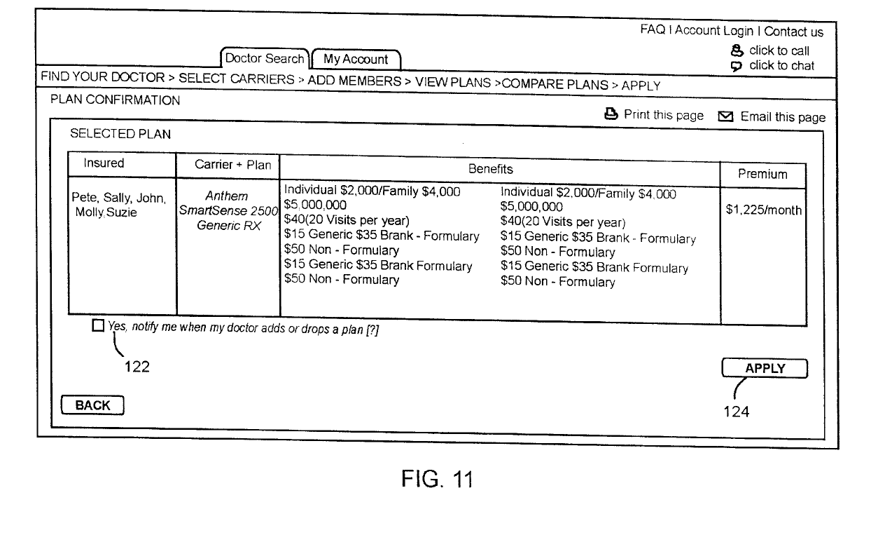

FIG. 11 is a screenshot of a web page illustrating completion and submission of at least one health insurance plan. The at least one health insurance plan selected by at least one user 12 along with a plurality of related information 104 is displayed. The at least one user 12 selects an option for user notification 122 to notify the at least one user 12 when at least one doctor adds or drops the at least one health insurance plan. The at least one user 12 clicks “APPLY” button 124 to submit the at least one health insurance plan.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method and system for enrolling at least one user in at least one health insurance plan by selecting at least one insurance carrier that is enrolled with at least one doctor, the at least one health insurance plan being accepted by the at least one doctor, the method comprising;
a. entering applicable information to search for the at least one doctor;
b. searching for the at least one doctor in a doctor database of the at least one insurance carrier;
c. displaying a search result that includes a list of details of the at least one doctor;
d. selecting the at least one doctor from the search result;
e. displaying the at least one insurance carrier enrolled with the at least one doctor;
f. selecting the at least one insurance carrier;
g. entering a plurality of details of at least one member to generate at least one rate quote, including gender, date of birth, whether the member smokes, and preferences for deductible or premium payments;
h. displaying the at least one health insurance plan that includes a plurality of related information, including type, deductible, co-pay, benefits summary, premiums, and ratings; i. comparing and selecting the at least one health insurance plan on the basis of a plurality of benefits, including the plurality of related information; the selection; and
j. completing and submitting the at least one health insurance plan selected by the at least one user.

2. The method of claim 1, wherein the at least one doctor is a medical doctor, a dentist, a veterinarian, a vision provider, and other health care professional.

3. The method of claim 1, wherein the at least one user can search for another doctor after selecting the at least one doctor from the search result.

4. The method of claim 1, wherein the method is applicable to an individual, a family, a small business, or a group.

5. The method of claim 1, wherein the applicable information is information helpful in selecting a doctor, including doctor name, zip code, distance from the user, address, city, state, and detailed information about the doctor.

6. The method of claim 1, wherein the search result shows a no match message when no entries are retrieved based on the applicable information.

7. The method of claim 1, wherein entering a plurality of details of at least one member to generate at least one rate quote is repeated for any additional members beyond one.

8. A method and system for enrolling at least one user in at least one health insurance plan by selecting at least one insurance carrier through a website that is enrolled with at least one doctor, the at least one health insurance plan being accepted by the at least one doctor, the method comprising;
a. entering applicable information to search for the at least one doctor;
b. searching for the at least one doctor in a doctor database of the at least one insurance carrier;
c. displaying a search result that includes a list of details of the at least one doctor; the search result being updatable through an edit function of the website allowing the user to change the applicable information, or through a function of the website allowing the user to add another doctor;
d. selecting the at least one doctor from the search result;
e. displaying the at least one insurance carrier enrolled with the at least one doctor;
f. selecting the at least one insurance carrier;
g. entering a plurality of details of at least one member to generate at least one rate quote, including gender, date of birth, whether the member smokes, and preferences for deductible or premium payments;
h. displaying the at least one health insurance plan that includes a plurality of related information, including type, deductible, co-pay, benefits summary, premiums, and ratings; the at least one user having the option of saving the at least one health insurance plan that includes a plurality of related information through the website; the at least one user having the option to customize and update the at least one health insurance plan through the website.
i. comparing and selecting the at least one health insurance plan on the basis of a plurality of benefits, including the plurality of related information; the selection; and
j. completing and submitting the at least one health insurance plan selected by the at least one user.

9. The method of claim 8,.wherein the option to customize and update the at least one health insurance plan through the website allows the user to change the deductible, copay limit, lifetime benefit, office visits, lab and x-rays, physical exams, mental services, prescription drugs, and out-patient surgery options.

10. The method of claim 8, wherein the at least one doctor is a medical doctor, a dentist, a veterinarian, a vision provider, and other health care professional.

11. The method of claim 8, wherein the at least one user can search for another doctor after selecting the at least one doctor from the search result.

12. The method of claim 8, wherein the method is applicable to an individual, a family, a small business, or a group.

13. The method of claim 8, wherein the applicable information is information helpful in selecting a doctor, including doctor name, zip code, distance from the user, address, city, state, and detailed information about the doctor.

14. The method of claim 8, wherein the search result shows a no match message when no entries are retrieved based on the applicable information.

15. The method of claim 8, wherein entering a plurality of details of at least one member to generate at least one rate quote is repeated for any additional members beyond one.
